(19) United States
(12) Patent Application Publication
(10) Pub. No.: US 2019/0206329 A1
(43) Pub. Date: Jul. 4, 2019

(54) DISPLAY DEVICE AND ELECTRONIC DEVICE INCLUDING THE SAME

(71) Applicant: Samsung Display Co., Ltd., Yongin-si (KR)

(72) Inventors: Donggyu LEE, Suwon-si (KR); Jaekeun LIM, Suwon-si (KR)

(21) Appl. No.: 16/208,096

(22) Filed: Dec. 3, 2018

(30) Foreign Application Priority Data
Jan. 3, 2018 (KR) 10-2018-0000948

(51) Int. Cl. G09G 3/3266; G09G 3/3275; G09G 3/36

(52) U.S. Cl. CPC G09G 3/3266; G09G 3/3275; G09G 3/3677; G09G 3/3688; G09G 2330/021; G09G 2310/0278; G09G 2310/08; G09G 2310/0286; G09G 2310/04

(57) ABSTRACT

A display device may include a display panel including a display panel including a plurality of pixels, a scan driver configured to provide a scan signal to the pixels, a data driver configured to provide a data signal to the pixels, and a controller configured to vary a frequency of a scan clock signal in one frame to partially drive the display panel, and to provide the scan clock signal to the scan driver.

### CROSS-REFERENCE TO RELATED APPLICATION

This application claims priority to, and the benefit of, Korean Patent Application No. 10-2018-0000948 filed on Jan. 3, 2018 in the Korean Intellectual Property Office (KIPO), the contents of which are incorporated herein in its entirety by reference.

### BACKGROUND

### 1. Field

Embodiments of the present disclosure relate generally to a display device capable of partially refreshing an image displayed on a display panel.

### 2. Description of the Related Art

Generally, a display device includes a display panel and a display panel driver. The display panel includes a plurality of scan-lines, a plurality of data-lines, and a plurality of pixels. The display panel driver includes a scan driver that provides a scan signal to the pixels via the scan-lines, and a data driver that provides a data signal to the pixels via the data-lines.

The scan driver may sequentially provide an activated scan signal from the first pixel-row to the last pixel-row of the display panel. Each of the pixels may receive the data signal from the data driver in response to the activated scan signal, and may emit light having luminance corresponding to the data signal.

The display device may be required to update only a portion of an entire image in a specific situation (e.g., in a standby mode). However, a conventional display device updates the entire image in each frame, and thus results in unnecessary power consumption.

### SUMMARY

Some embodiments of the present disclosure provide a display device that can partially drive a display panel.

Some embodiments of the present disclosure provide an electronic device including the display device.

According to an aspect of embodiments of the present disclosure, a display device may include a display panel including a display panel including a plurality of pixels, a scan driver configured to provide a scan signal to the pixels, a data driver configured to provide a data signal to the pixels, and a controller configured to vary a frequency of a scan clock signal in one frame to partially drive the display panel, and to provide the scan clock signal to the scan driver.

The controller may be configured to select, as a driving mode, a first driving mode in which the display panel is entirely driven, or a second driving mode in which the display panel is partially driven.

The pixels may be arranged in a plurality of pixel-rows and a plurality of pixel-columns, and the controller may be configured to classify, in the second driving mode, the pixel-rows into a first region where an image displayed on the display panel is to be refreshed, and a second region where the image displayed on the display panel is not to be refreshed.

In the second driving mode, the scan driver may be configured to provide the scan signal that is activated to the first region, and to provide the scan signal that is deactivated to the second region.

The controller may be configured to select the first driving mode or the second driving mode by comparing a previous frame data of image data with a current frame data of the image data.

The controller may be configured to provide the scan clock signal having a first frequency to the scan driver in a first period of the frame, to provide the scan clock signal having a second frequency that is lower than the first frequency to the scan driver in a second period of the frame, and to provide the scan clock signal having a constant voltage level to the scan driver in a third period of the frame.

The scan driver may be configured to output the scan signal that is deactivated based on the scan clock signal having the first frequency or having the constant voltage level, and to output the scan signal that is activated based on the scan clock signal having the second frequency.

The scan driver may include a shift register configured to sequentially output a plurality of output signals based on the scan clock signal and a start signal, a signal filter configured to attenuate the output signals when a frequency of the output signals is greater than a predetermined frequency, and a level shifter configured to convert the attenuated output signals into the scan signals having a turn-on voltage or a turn-off voltage.

The shift register may include first through (n)th flip-flops, where n is an integer greater than 1, that are configured to output the output signals, respectively, wherein the scan driver further includes a selector that is configured to provide the start signal to one of the first through (n)th flip-flops based on region classification information indicating a region of the display panel to be driven, and wherein the (k)th flip-flop, where k is an integer between 2 and n, is configured to generate one of the output signals in response to the output signal of the (k−1)th flip-flop or the start signal.

The scan driver may include first through (n)th stages, where n is an integer greater than 1, that are configured to output respective output signals, wherein the (k)th stage, where k is an integer between 2 and n, is configured to output one of the output signals in response to the output signal of the (k−1)th stage or a start signal.

The scan driver may further include a selector that is configured to provide the start signal to one of the first through (n)th stages based on region classification information indicating a region of the display panel to be driven.

The controller may include a frame data comparing block configured to obtain a first number of pixel-rows where previous frame data is identical to current frame data, a partial refresh determining block configured to generate region classification information for classifying the pixel-rows into a first region where an image displayed on the display panel is to be refreshed, and a second region where the image displayed on the display panel is not to be refreshed, when the first number is greater than a threshold value, and a control signal generating block configured to vary the frequency of the scan clock signal based on the region classification information.

The control signal generating block may be configured to provide a data clock signal of which a frequency is varied based on the region classification information to the data driver.

According to an aspect of embodiments of the present disclosure, an electronic device may include an image processing device configured to generate image data from an image source, and a display device configured to display an image corresponding to the image data, wherein the display device includes a display panel including a plurality of pixels, a scan driver configured to provide a scan signal to the pixels, a data driver configured to provide a data signal to the pixels, and a controller configured to vary a frequency of a scan clock signal in one frame to partially drive the display panel based on the image data, and to provide the scan clock signal to the scan driver.

The image processing device may partially provide current frame data of the image data to the display device when the current frame data of the image data is partially updated from previous frame data of the image data.

The image processing device may be configured to determine a frame rate based on a size of a portion of the current frame data, the portion of the current frame data being provided to the display device.

The controller may be configured to select a first driving mode in which the display panel is entirely driven or a second driving mode in which the display panel is partially driven as a driving mode.

The pixels may be arranged in a plurality of pixel-rows and a plurality of pixel-columns, and the controller may be configured to classify, in the second driving mode, the pixel-rows into a first region where an image displayed on the display panel is to be refreshed, and a second region where the image displayed on the display panel is not to be refreshed.

In the second driving mode, the scan driver may be configured to provide the scan signal that is activated to the first region, and to provide the scan signal that is deactivated to the second region.

The controller may be configured to provide the scan clock signal having a first frequency to the scan driver in a first period of the frame, to provide the scan clock signal having a second frequency that is lower than the first frequency to the scan driver in a second period of the frame, and to provide the scan clock signal having a constant voltage level to the scan driver in a third period of the frame.

Therefore, a display device according to embodiments of the present disclosure may partially drive a display panel by providing an activated scan signal to only a portion of pixel-rows included in the display panel by varying (or, adjusting) a frequency of a clock signal (e.g., a scan clock signal) of a scan driver in one frame. Thus, when only a portion of an image displayed on the display panel is updated, the display device may reduce power consumption by partially driving the display panel.

In addition, an electronic device including the display device according to embodiments of the present disclosure may transmit image data (e.g., partial frame data) at a variable frame rate between the electronic device and the display device. Here, the electronic device may drive the display device at a relatively high frequency to partially drive the display panel of the display device.

### BRIEF DESCRIPTION OF THE DRAWINGS

Illustrative, non-limiting embodiments of the present disclosure will be more clearly understood from the following detailed description taken in conjunction with the accompanying drawings.

FIG. 1 is a block diagram illustrating a display device according to embodiments of the present disclosure.

FIG. 2 is a block diagram illustrating an example of a timing controller included in the display device of FIG. 1.

FIG. 3 is a block diagram illustrating an example of a scan driver included in the display device of FIG. 1.

FIG. 4 is a timing diagram illustrating an example in which the scan driver of FIG. 3 is driven in a first driving mode.

FIG. 5 is a timing diagram illustrating an example in which the scan driver of FIG. 3 is driven in a second driving mode.

FIGS. 6A and 6B are diagrams illustrating an example in which a display panel included in the display device of FIG. 1 is partially driven.

FIG. 7 is a block diagram illustrating another example of a scan driver included in the display device of FIG. 1.

FIG. 8 is a block diagram illustrating still another example of a scan driver included in the display device of FIG. 1.

FIG. 9 is a circuit diagram illustrating an example of a stage included in the scan driver of FIG. 8.

FIG. 10 is a block diagram illustrating another example of a timing controller included in the display device of FIG. 1.

FIG. 11 is a block diagram illustrating still another example of a scan driver included in the display device of FIG. 1.

FIG. 12 is a timing diagram illustrating an example in which the scan driver of FIG. 11 is driven in a second driving mode.

FIG. 13 is a block diagram illustrating still another example of a scan driver included in the display device of FIG. 1.

FIG. 14 is a block diagram illustrating an electronic device according to embodiments of the present disclosure.

FIGS. 15A and 15B are diagrams illustrating examples in which a frame rate is adjusted between an image processing device and a display device included in the electronic device of FIG. 14.

### DETAILED DESCRIPTION

Hereinafter, embodiments of the present inventive concept will be explained in detail with reference to the accompanying drawings.

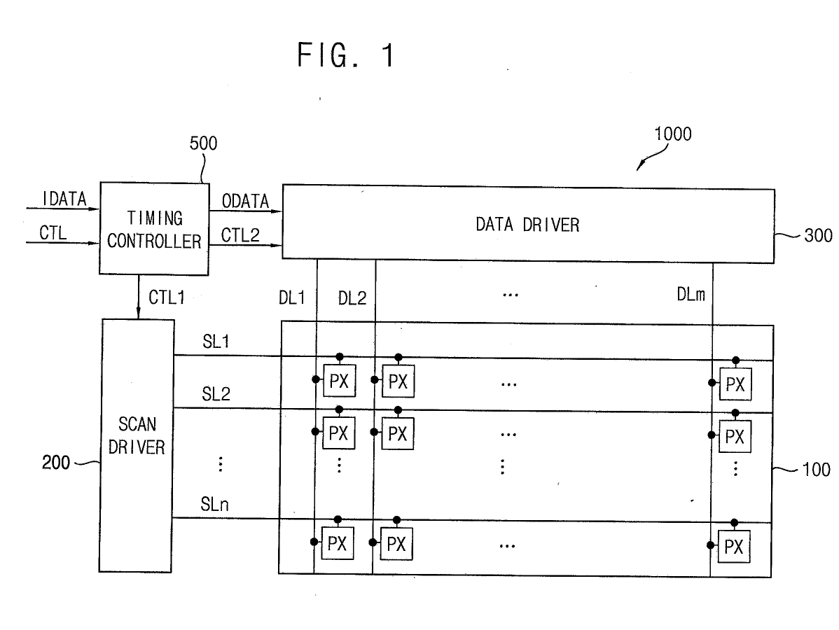

FIG. 1 is a block diagram illustrating a display device according to embodiments of the present disclosure.

Referring to FIG. 1, the display device 1000 may include a display panel 100, a scan driver 200, a data driver 300, and a timing controller 500. In an embodiment, the display device 1000 may be an organic light emitting display (OLED) device. In this case, the display device 1000 may further include an emission control driver that provides an emission control signal to pixels PX of the display panel 100. In another embodiment, the display device 1000 may be a liquid crystal display (LCD) device. In this case, the display device 1000 may further include a backlight assembly.

The display panel 100 may include a plurality of pixels PX to display an image. The pixels PX may be arranged in a plurality of pixel-rows and a plurality of pixel-columns. For example, the display panel 100 may include n×m pixels PX that are arranged at intersections of first through (n)th scan-lines SL1 through SLn and first through (m)th data-lines DL1 through DLm, where n and m are integers greater than 1. In this case, the display panel 100 may include first through (n)th pixel-rows and first through (m)th pixel-columns.

The scan driver 200 may provide a scan signal to the pixels PX via the first through (n)th scan-lines SL1 through SLn based on a first control signal CTL1.

In an embodiment, in a first driving mode in which an entire region of the display panel 100 is driven, the scan driver 200 may sequentially provide an activated scan signal to the first through (n)th scan-lines SL1 through SLn. In addition, in a second driving mode in which only a portion of the entire region of the display panel 100 is driven, the scan driver 200 may provide the activated scan signal to a first region where an image is to be refreshed, and may provide a deactivated scan signal to a second region where the image is not to be refreshed. In other words, to partially drive the display panel 100 in the second driving mode, the scan driver 200 may output the activated scan signal to the pixel-rows belonging to the first region while not outputting the activated scan signal to the pixel-rows belonging to the second region.

In an embodiment, the scan driver 200 may output the deactivated scan signal based on a scan clock signal having a first frequency (e.g., a relatively high frequency) or having a constant voltage level. On the other hand, the scan driver 200 may output the activated scan signal based on a scan clock signal having a second frequency that is lower than the first frequency. That is, because the scan driver 200 outputs the activated scan signal to only a portion of the pixel-rows according to the scan clock signal received from the timing controller 500, only the portion of the image displayed on the display panel 100 may be refreshed (e.g., the image displayed on the display panel 100 may be partially refreshed).

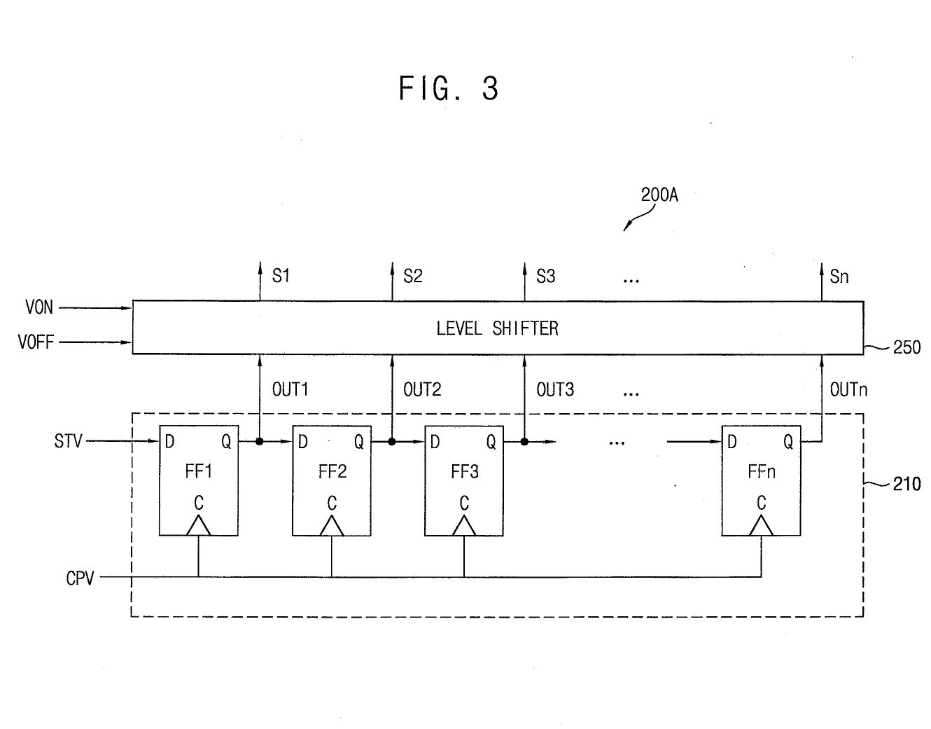

A structure and an operation of the scan driver 200 will be described in detail with reference to FIGS. 3 to 5, FIGS. 7 to 9, and FIGS. 11 to 13.

The data driver 300 may convert digital image data ODATA to an analog data voltage (or, the data signal) based on a second control signal CTL2, and may provide the analog data voltage to the pixels PX via the first through (m)th data-lines DL1 through DLm.

The timing controller 500 may control the scan driver 200 and the data driver 300. For example, the timing controller 500 may receive a control signal CTL from an external component (e.g., a system board). The timing controller 500 may generate the first control signal CTL1 and the second control signal CTL2 to control the scan driver 200 and the data driver 300, respectively. The first control signal CTL1 for controlling the scan driver 200 may include a vertical start signal, a scan clock signal, etc. The second control signal CTL2 for controlling the data driver 300 may include a horizontal start signal, a data clock signal, etc. The timing controller 500 may generate the digital image data ODATA adapted to operating conditions of the display panel 100 based on input image data IDATA, and may provide the digital image data ODATA to the data driver 300.

To partially drive the display panel 100, the timing controller 500 may vary (or, change) a frequency of the scan clock signal in one frame, and may provide the scan clock signal to the scan driver 200. In an embodiment, the timing controller 500 may select, as a driving mode, one of the first driving mode in which the display panel 100 is entirely (or, wholly) driven, and the second driving mode in which the display panel 100 is partially driven. The timing controller 500 may select the first driving mode or the second driving mode by comparing a previous frame data of the input image data IDATA and a current frame data of the input image data IDATA. For example, the timing controller 500 may count the number of the pixel-rows where the current frame data is identical to the previous frame data, and may select the second driving mode for partially driving the display panel 100 when the counted number of the pixel-rows is greater than a predetermined threshold value. In other words, the timing controller 500 may partially refresh the image displayed on the display panel 100 when only a portion of the current frame data is updated from the previous frame data.

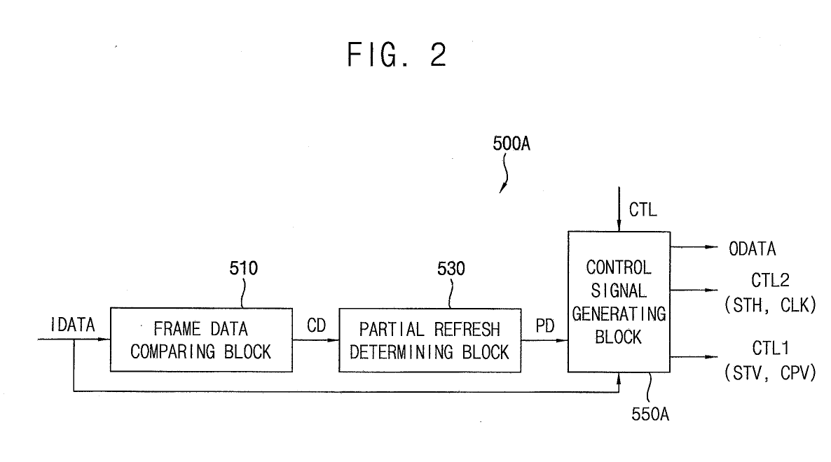

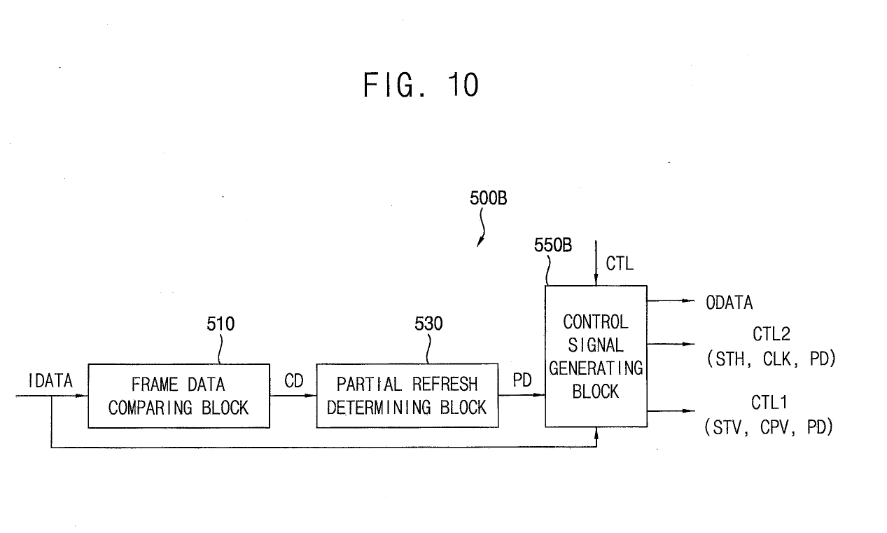

A structure and an operation of the timing controller 500 will be described in detail with reference to FIGS. 2 and 10.

Thus, the display device 1000 may provide the activated scan signal to only the portion of the pixel-rows included in the display panel 100 to partially drive the display panel 100 by varying the frequency of the scan clock signal in one frame. As a result, when the portion of the image is updated, the display device 1000 may reduce power consumption by partially driving the display panel 100.

FIG. 2 is a block diagram illustrating an example of a timing controller included in the display device of FIG. 1.

Referring to FIG. 2, the timing controller 500A may include a frame data comparing block 510, a partial refresh determining block 530, and a control signal generating block 550A.

The frame data comparing block 510 may obtain or generate the number CD of the pixel-rows where the previous frame data of the input image data IDATA is identical to the current frame data of the input image data IDATA. That is, the frame data comparing block 510 may check whether the previous frame data is identical to the current frame data with respect to units of pixel-rows to determine the driving mode.

The partial refresh determining block 530 may select the second driving mode in which the display device is partially driven when the number CD of the pixel-rows where the previous frame data is identical to the current frame data is greater than the predetermined threshold value. When the second driving mode is selected, the partial refresh determining block 530 may generate region classification information PD by classifying (or dividing) the pixel-rows into the first region where the image displayed on the display panel is to be refreshed, and the second region where the image displayed on the display panel is not to be refreshed. For example, when the previous frame data is identical to the current frame data at 100 or more consecutive pixel-rows, the partial refresh determining block 530 may set the 100 or more pixel-rows as the second region. Here, the region classification information PD may include information for classifying the pixel-rows into the first region and the second region. For example, the region classification information PD may include a start pixel-row and an end pixel-row of the first region.

The control signal generating block 550A may generate the first control signal CTL1 for controlling the scan driver, the second control signal CTL2 for controlling the data driver, and output image data ODATA based on the control signal CTL and the region classification information PD. The control signal CTL may include a horizontal synchronization signal, a vertical synchronization signal, and a reference clock signal. In an embodiment, the control signal generating block 550A may generate the digital image data ODATA adapted to the operating conditions of the display panel 100 based on the input image data IDATA. The control signal generating block 550A may generate a horizontal start signal STH using the horizontal synchronization signal, and may provide the horizontal start signal STH to the data driver. The control signal generating block 550A may generate a vertical start signal SW using the vertical synchronization signal, and may provide the vertical start signal STV to the scan driver. In addition, the control signal generating block 550A may generate a scan clock signal CPV and a data clock signal CLK using the reference clock signal, may provide the scan clock signal CPV to the scan driver, and may provide the data clock signal CLK to the data driver.

The control signal generating block 550A may vary the frequency of the scan clock signal CPV based on the region classification information PD in one frame. For example, in one frame, the control signal generating block 550A may generate the scan clock signal CPV having a relatively high frequency (e.g., the first frequency) such that the activated scan signal is not output during a first period corresponding to the second region before the start pixel-row of the first region. Subsequently, the control signal generating block 550A may generate the scan clock signal CPV having a normal frequency (e.g., the second frequency) such that the activated scan signal is sequentially provided to the first region during a second period corresponding to the first region. Next, the control signal generating block 550A may generate the scan clock signal CPV having a constant voltage level during a third period corresponding to the second region such that the activated scan signal is not provided to the second region during the third period.

In an embodiment, the control signal generating block 550A may provide the data clock signal CLK of which a frequency is varied based on the region classification information PD provided to the data driver, such that the data driver outputs the data signal corresponding to the second region. That is, the control signal generating block 550A may vary the frequency of the data clock signal CLK to adjust an output timing of the data signal corresponding to the first region in the second driving mode.

FIG. 3 is a block diagram illustrating an example of a scan driver included in the display device of FIG. 1.

Referring to FIG. 3, the scan driver 200A may include a shift register 210 and a level shifter 250.

The shift register 210 may sequentially output a plurality of output signals OUT1 through OUTn based on the scan clock signal CPV and the vertical start signal STV. The shift register 210 may include first through (n)th stages FF1 through FFn that output the output signals OUT1 through OUTn, respectively. The (k)th stage may generate the (k)th output signal in response to the output signal of the (k−1)th stage or in response to the vertical start signal STV, where k is an integer between 2 and n.

In an embodiment, the shift register 210 may include first through (n)th flip-flops FF1 through FFn that are connected in a cascade structure. Each of the first through (n)th flip-flops FF1 through FFn may include an input terminal D, an output terminal Q, and a clock terminal C.

The clock terminal C of each of the first through (n)th flip-flops FF1 through FFn may receive the scan clock signal CPV. The input terminal D of the first flip-flop FF1 may receive the vertical start signal SW. The input terminal D of each of the second through (n)th flip-flops FF2 through FFn may receive the output signal of the previous flip-flop. For example, the input terminal D of the second flip-flop FF2 may be connected to the output terminal Q of the first flip-flop FF1. Thus, the input terminal D of the second flip-flop FF2 may receive the first output signal OUT1 of the first flip-flop FF1. Similarly, the input terminal D of the third flip-flop FF3 may be connected to the output terminal Q of the second flip-flop FF2. Thus, the input terminal D of the third flip-flop FF3 may receive the second output signal OUT2 of the second flip-flop FF2.

The first through (n)th flip-flops FF1 through FFn may sequentially output the first through (n)th output signals OUT1 through OUTn, respectively. That is, the first through (n)th output signals OUT1 through OUTn may have a waveform sequentially shifted by an amount of time.

The level shifter 250 may convert the output signals OUT1 through OUTn into the scan signals S1 through Sn having a turn-on voltage VON or a turn-off voltage VOFF. For example, the turn-on voltage VON may turn on a switching transistor included in the pixel, and the turn-off voltage VOFF may turn off the switching transistor. Because each of the first through (n)th output signals OUT1 through OUTn has a square wave shape, the level shifter 250 may convert the first through (n)th output signals OUT1 through OUTn to the first through (n)th scan signals S1 through Sn. In other words, a high voltage level of the output signal may correspond to the turn-on voltage VON, and a low voltage level of the output signal may correspond to the turn-off voltage VOFF.

Although it is illustrated in FIG. 3 that the scan driver 200A includes the shift register 210 including the flip-flops FF1 through FFn and the level shifter 250, the scan driver 200A may have various structures that can partially output the scan signal as the frequency of the scan clock signal is varied (or adjusted). For example, the scan driver 200A may not include the level shifter 250. In other words, the scan driver 200A may include only the shift register 210. In this case, an output of the shift register 210 may be provided to the pixels as the scan signal.

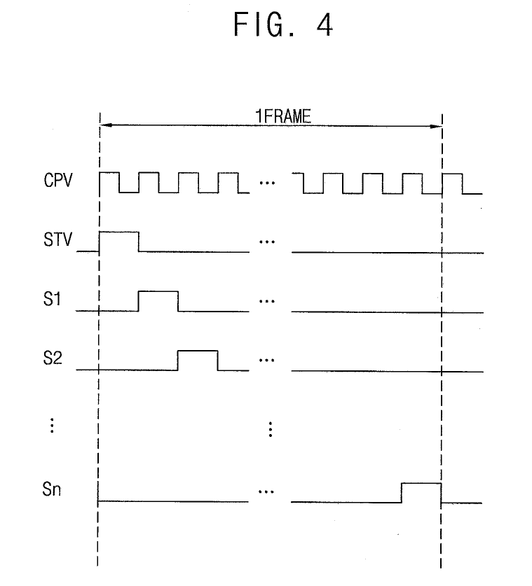

FIG. 4 is a timing diagram illustrating an example in which the scan driver of FIG. 3 is driven in a first driving mode.

Referring to FIGS. 3 and 4, in the first driving mode, the scan driver 200A may sequentially output first through (n)th scan signals S1 through Sn, which are activated, in one frame.

For example, in the first driving mode, the first stage FF1 of the scan driver 200A may receive an activated (or a high voltage level) vertical start signal STV. The first stage FF1 may output the first output signal OUT1, which is activated, based on the vertical start signal STV. The level shifter 250 may provide the first scan signal S1 corresponding to the first output signal OUT1 to the first pixel-row via the first scan-line.

The second stage FF2 of the scan driver 200A may receive the first output signal OUT1. The second stage FF2 may output the second output signal OUT2 corresponding to a signal generated by delaying the first output signal OUT1 by a given amount of time. The level shifter 250 may provide the second scan signal S2 corresponding to the second output signal OUT2 to the second pixel-row via the second scan-line.

In the same way, the third through (n)th stages FF3 through FFn may sequentially generate the third through (n)th output signals OUT3 through OUTn, respectively. The level shifter 250 may sequentially provide the third through (n)th scan signals S3 through Sn corresponding to the third through (n)th output signals OUT3 through OUTn to the third through (n)th pixel-rows via the third through (n)th scan-lines, respectively.

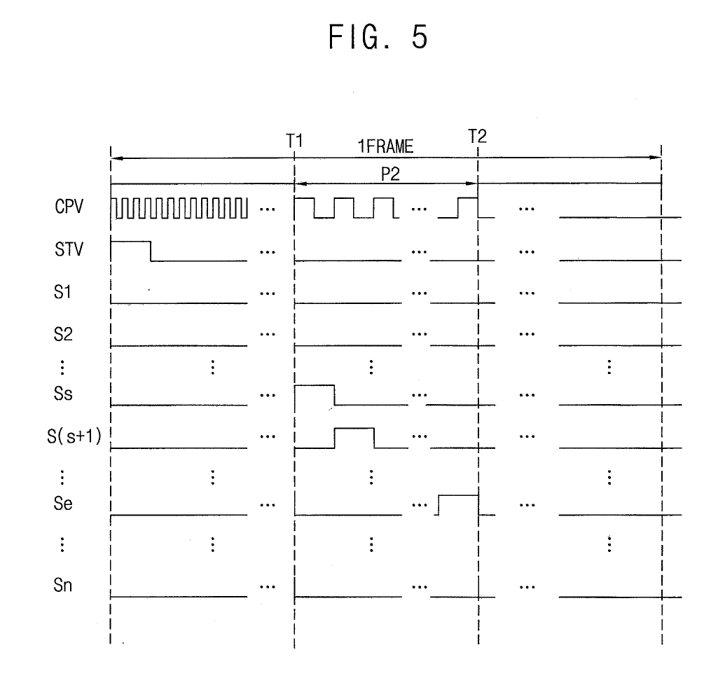

FIG. 5 is a timing diagram illustrating an example in which the scan driver of FIG. 3 is driven in a second driving mode.

Referring to FIGS. 3 and 5, in the second driving mode, the scan driver 200A may sequentially provide the activated scan signal to the scan-lines belonging to the first region in one frame. On the other hand, the scan driver 200A might not provide the activated scan signal to the scan-lines belonging to the second region in one frame.

For example, in the second driving mode, the scan driver 200A may receive the scan clock signal CPV having the first frequency during the first period P1 between a start point of one frame and a first point T1 corresponding to the start pixel-row of the first region. That is, the scan driver 200A may receive the scan clock signal CPV having the first frequency until the first point T1 corresponding to the start pixel-row of the first region is reached. To reduce a time length of the first period P1, the first frequency may be relatively high. For example, a cycle of the scan clock signal CPV during the first period P1 may be about 0.15 microseconds (μs). Thus, the first point T1 corresponding to the start pixel-row of the first region may be reached relatively quickly.

During the first period P1, the stages of the scan driver 200A may sequentially generate the activated output signal. However, the activated scan signal might not be generated due to a charging time of the scan signal and due to RC loads of the display panel.

The scan driver 200A may receive the scan clock signal CPV having the second frequency, which is lower than the first frequency, during the second period P2 between the first point T1 corresponding to the start pixel-row of the first region (e.g., the (s)th pixel-row, where s is an integer between 1 and n) and a second point T2 corresponding to the pixel-row that is next to the end pixel-row of the first region (e.g., the (e)th pixel-row, where e is an integer between s and n). For example, the second frequency may be the same as the frequency of the scan clock signal CPV in the first driving mode. During the second period P2, the cycle of the scan clock signal CPV may be about 15 μs.

In the second period P2, the (s)th through (e)th stages may sequentially generate the (s)th through (e)th output signals. The level shifter 250 may sequentially provide the (s)th through (e)th scan signals Ss through Se, which correspond to the (s)th through (e)th output signals, respectively, to the (s)th through (e)th pixel-rows corresponding to the first region via the (s)th through (e)th scan-lines.

The scan driver 200A may receive the scan clock signal CPV having a constant voltage level (e.g., a low voltage level) during the third period P3 after the second point T2. Thus, the scan driver 200A might not output the activated scan signal anymore during the third period P3.

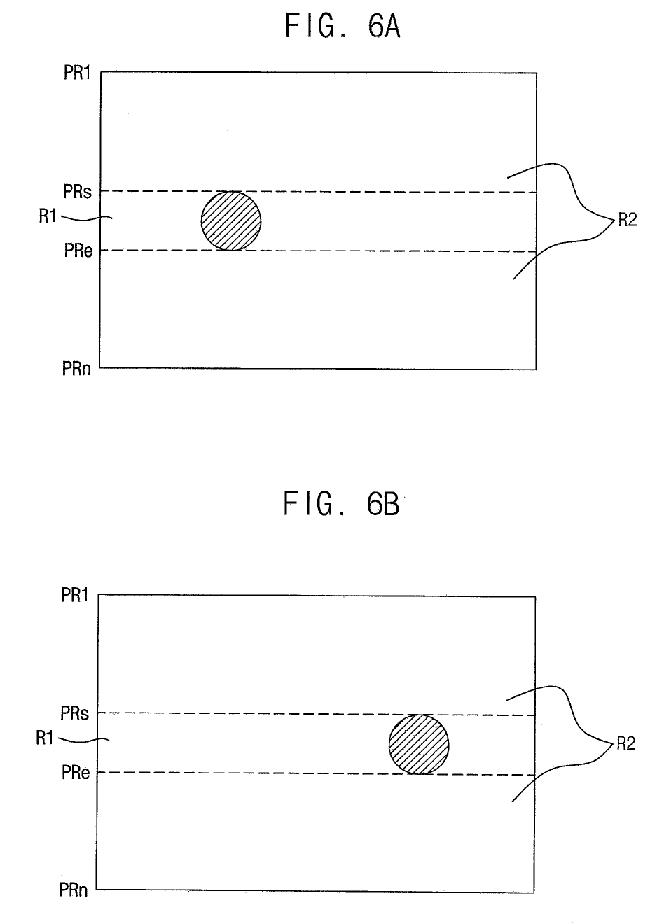

FIGS. 6A and 6B are diagrams illustrating an example in which a display panel included in the display device of FIG. 1 is partially driven.

Referring to FIGS. 6A and 6B, the display device may partially drive the display panel by including the scan driver that provides the activated scan signal to only the pixel-rows corresponding to the first region R1.

As illustrated in FIG. 6A, first frame data (e.g., data of a first frame) may correspond to an image having a circle shape located to the left of a center in a white background. On the other hand, as illustrated in FIG. 6B, second frame data (e.g., data of a second frame) may correspond to an image having a circle shape located at a right of the center in the white background. In this case, the display device may determine the second driving mode as the driving mode, may determine a region corresponding to the (s)th through (e)th pixel-rows PRs through PRe as the first region R1, and may determine another region (or, a remaining region) as the second region R2.

In the second frame, the display device may provide the activated scan signal to only the (s)th through (e)th pixel-rows PRs through PRe among the first through (n)th pixel-rows PR1 through PRn. Thus, in the second frame, the display device may refresh an image of the first region R1 while maintaining a previous image as an image of the second region R2.

Although it is illustrated in FIGS. 5, 6A, and 6B that the display panel includes one first region in the second frame, the display panel may include a plurality of first regions.

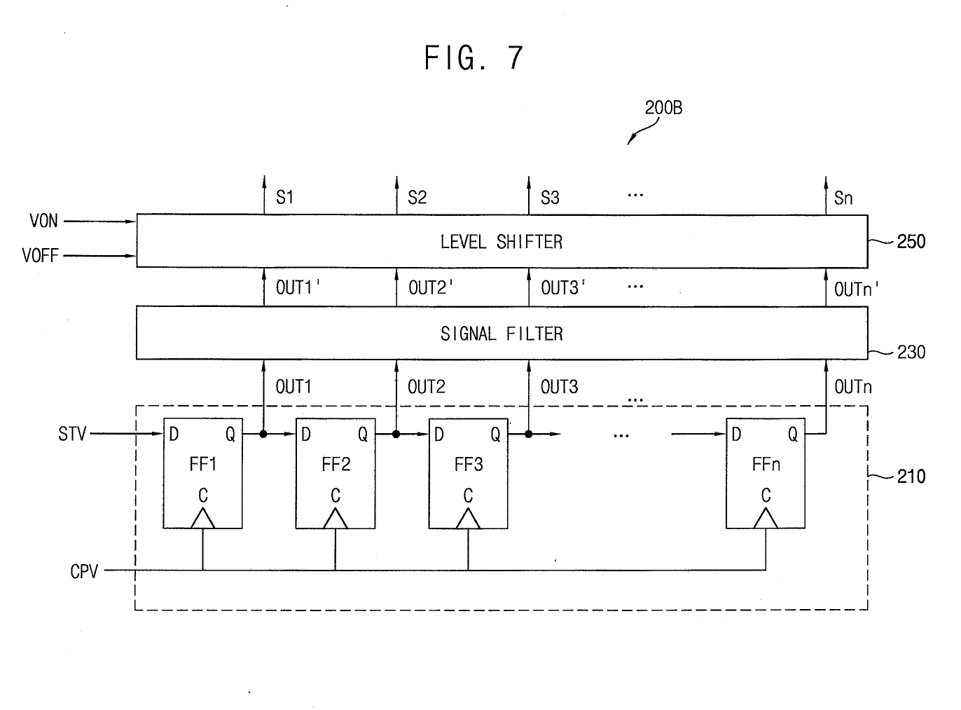

FIG. 7 is a block diagram illustrating another example of a scan driver included in the display device of FIG. 1.

Referring to FIG. 7, the scan driver 200B may include a shift register 210, a signal filter 230, and a level shifter 250. Except that the scan driver 200B further includes the signal filter 230, the scan driver 200B may be substantially the same as the scan driver 200A of FIG. 3. Thus, the same or similar reference numerals will be used for identical or similar components. In addition, duplicated description will not be repeated.

The shift register 210 may sequentially output a plurality of output signals OUT1 through OUTn based on the scan clock signal CPV and the vertical start signal SN.

The signal filter 230 may attenuate the output signals OUT1 through OUTn when respective frequencies of the output signals OUT1 through OUTn are greater than a predetermined frequency. In other words, the signal filter 230 may attenuate the output signals OUT1 through OUTn to prevent the activated scan signals S1 through Sn from being output when the scan clock signal STV has the first frequency (e.g., a relatively high frequency). Hence, because the activated scan signal is not output during the first period, an abnormal displaying operation may be prevented, and thus reliability of the display device may be improved. For example, the signal filter 230 may include a low pass filter.

The level shifter 250 may convert the attenuated output signals OUT1′ through OUTn′ into the scan signals S1 through Sn having the turn-on voltage or the turn-off voltage.

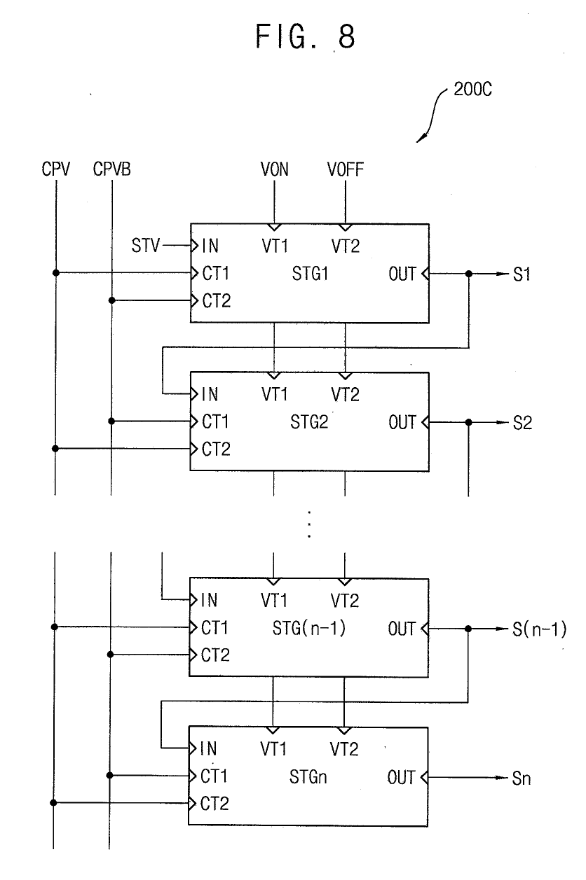

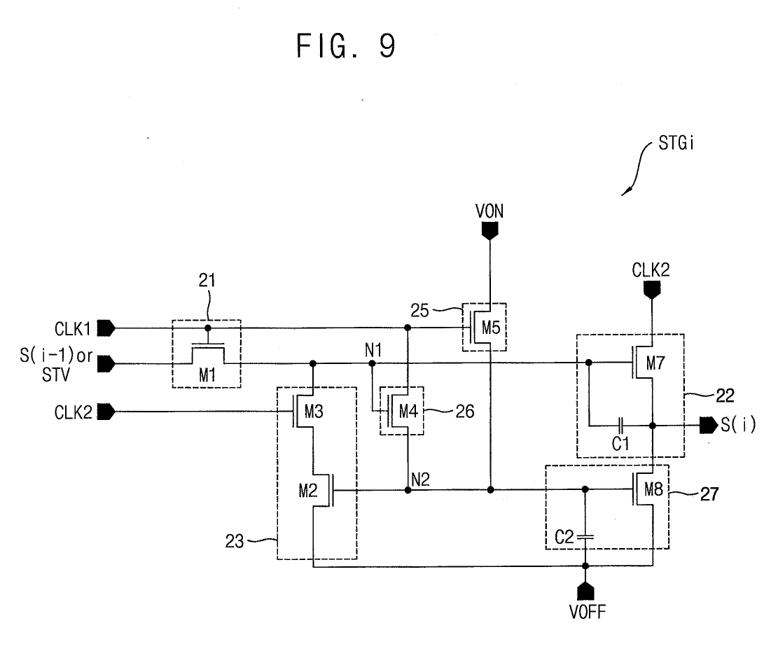

FIG. 8 is a block diagram illustrating still another example of a scan driver included in the display device of FIG. 1, and FIG. 9 is a circuit diagram illustrating an example of a stage included in the scan driver of FIG. 8.

Referring to FIGS. 8 and 9, the scan driver 200C may be formed on the same substrate as the display panel. The scan driver 200C may include a plurality of stages STG1 through STGn. Each of the stages STG1 through STGn may include an input terminal IN, a first clock terminal CT1, a second clock terminal CT2, a first power terminal VT1, a second power terminal VT2, and an output terminal OUT.

The first scan clock signal CPV and the second scan clock signal CPVB, which have different timings, may be respectively input to the first clock terminal CT1 and the second clock terminal CT2 of the stages STG1 through STGn. For example, the second scan clock signal CPVB may be an inverted signal of the first scan clock signal CPV. The first and second clock signals CPV and CPVB may be applied to adjacent ones of the stages STG1 through STGn in reverse. For example, the first scan clock signal CPV may be applied, as the first clock signal, to the first clock terminal CT1 of odd stages (e.g., STG1), and the second scan clock signal CPVB may be applied, as the second clock signal, to the second clock terminal CT2 of the odd stages (e.g., STG1). On the other hand, the second scan clock signal CPVB may be applied, as the first clock signal, to the first clock terminal CT1 of even stages (e.g., STG2), and the first scan clock signal CPV may be applied, as the second clock signal, to the second clock terminal CT2 of the even stages (e.g., STG2).

In the second driving mode, the frequency of the first scan clock signal CPV and the frequency of the second scan clock signal CPVB may be varied in one frame such that the display panel 100 is partially driven in that frame. In an embodiment, in one frame, the first scan clock signal CPV and the second scan clock signal CPVB that have a relatively high frequency (e.g., the first frequency) may be generated such that the activated scan signal is not output during the first period corresponding to the second region that is before the start pixel-row of the first region.

Subsequently, the first scan clock signal CPV and the second scan clock signal CPVB that have a normal frequency (e.g., the second frequency) may be generated such that the activated scan signal is sequentially applied to the first region during the second period corresponding to the first region.

Next, the first scan clock signal CPV and the second scan clock signal CPVB that have a constant voltage level may be generated such that the activated scan signal is not applied to the second region during the third period corresponding to the second region. Because a method in which the scan driver 200C of FIG. 8 drives the display panel by varying the frequency of the first scan clock signal CPV and the frequency of the second scan clock signal CPVB is substantially the same as a method in which the scan driver 200A of FIG. 3 drives the display panel, duplicated description will not be repeated.

The output signal of the previous stage or the vertical start signal STV may be applied to the input terminal IN of the stages STG1 through STGn. That is, the vertical start signal STV may be applied to the input terminal IN of the first stage STG1, and the output signal of the previous stage may be applied to the input terminal IN of the second through (n)th stages STG2 through STGn. The output terminal OUT of the stages STG1 through STGn may output the output signal to the scan-line.

The turn-on voltage VON capable of turning on a switching transistor included in a pixel may be applied to the first power terminal VT1 of the stages STG1 through STGn. For example, the turn-on voltage VON may be a voltage having a high voltage level. The turn-off voltage VOFF capable of turning off the switching transistor included in the pixel may be applied to the second power terminal VT2 of the stages STG1 through STGn. For example, the turn-off voltage VOFF may be a voltage having a low voltage level.

As illustrated in FIG. 9, each stage STGi of the scan driver 200C may include a first input block 21, a second input block 26, a first output block 22, a second output block 27, a stabilization block 23, and a holding block 25.

The first input block 21 may receive the output signal S(i−1) of one previous stage or may receive the vertical start signal STV as the input signal, and may apply the input signal to a first node N1 in response to the first clock signal CLK1. Here, the first clock signal CLK1 applied to the first clock terminal may be the first scan clock signal in the odd stage. In addition, the first clock signal CLK1 applied to the first clock terminal may be the second scan clock signal in the even stage.

The first input block 21 may apply the input signal to the first node N1 in response to the first clock signal CLK1. In an embodiment, the first input block 21 may include a first input transistor M1. The first input transistor M1 may include a gate electrode that receives the first clock signal CLK1, a first electrode that receives the input signal, and a second electrode connected to the first node N1.

The second input block 26 may apply the first clock signal CLK1 to the second node N2 in response to a signal of the first node N1. In an embodiment, the second input block 26 may include a second input transistor M4. The second input transistor M4 may include a gate electrode connected to the first node N1, a first electrode that receives the first clock signal CLK1, and a second electrode connected to the second node N2.

The first output block 22 may control the output signal S(i) to have an activation level in response to the signal of the first node N1. In an embodiment, the first output block 22 may include a first output transistor M7 and a first capacitor C1. The first output transistor M7 may include a gate electrode connected to the first node N1, a first electrode that receives the second clock signal CLK2, and a second electrode connected to an output terminal at which the output signal S(i) is output. The first capacitor C1 may include a first electrode connected to the first node N1 and a second electrode connected to the output terminal. Here, the second clock signal CLK2 applied to the second clock terminal may be the second scan clock signal in the odd stage. In addition, the second clock signal CLK2 applied to the second clock terminal may be the first scan clock signal in the even stage.

The second output block 27 may control the output signal S(i) to have a deactivation level in response to a signal of the second node N2. In an embodiment, the second output block 27 may include a second output transistor M8 and a second capacitor C2. The second output transistor M8 may include a gate electrode connected to the second node N2, a first electrode that receives the turn-off voltage VOFF, and a second electrode connected to the output terminal. The second capacitor C2 may include a first electrode connected to the second node N2 and a second electrode that receives the turn-off voltage VOFF. In an embodiment, the first output block 22 and the second output block 27 may act as a level shifter according to the second clock signal CLK2 and the turn-off voltage VOFF.

The stabilization block 23 may stabilize the output signal S(i) in response to the signal of the second node N2 and the second clock signal CLK2. In an embodiment, the stabilization block 23 may include a first stabilization transistor M2 and a second stabilization transistor M3. The first stabilization transistor M2 may include a gate electrode connected to the second node N2, the first electrode that receives the turn-off voltage VOFF, and a second electrode. The second stabilization transistor M3 may include a gate electrode that receives the second clock signal CLK2, a first electrode connected to the second electrode of the first stabilization transistor M2, and a second electrode connected to the first node N1.

The holding block 25 may maintain the signal of the second node N2 to have a first logical level in response to the first clock signal CLK1. In an embodiment, the holding block 25 may include a holding transistor M5. The holding transistor M5 may include a gate electrode 25 that receives the first clock signal CLK1, a first electrode that receives the turn-on voltage VON, and a second electrode connected to the second node N2.

FIG. 10 is a block diagram illustrating another example of a timing controller included in the display device of FIG. 1.

Referring to FIG. 10, the timing controller 500B may include a frame data comparing block 510, a partial refresh determining block 530, and a control signal generating block 550B. Except that the timing controller 500B provides the region classification information PD as a control signal to the scan driver and the data driver to reach the point corresponding to the start pixel-row of the first region, instead of increasing the frequency of the clock signal, the timing controller 500B is substantially the same as the timing controller 500A of FIG. 2. Thus, the same reference numerals will be used for identical or similar components. In addition, duplicated description will not be repeated.

The frame data comparing block 510 may obtain the number CD of the pixel-rows where the previous frame data of the input image data IDATA is identical to the current frame data of the input image data IDATA.

The partial refresh determining block 530 may select the second driving mode for partially driving the display panel when the number CD of the pixel-rows where the previous frame data is identical to the current frame data is greater than a threshold value. When the second driving mode is selected, the partial refresh determining block 530 may classify the pixel-rows into the first region where the image displayed on the display panel is to be refreshed, and into the second region where the image displayed on the display panel is not to be refreshed, and may generate the region classification information PD.

The control signal generating block 550B may generate the first control signal CTL1 for controlling the scan driver, the second control signal CTL2 for controlling the data driver, and the output image data ODATA based on the control signal CTL and the region classification information PD.

The control signal generating block 550B may vary the frequency of the scan clock signal CPV based on the region classification information PD in one frame. For example, the control signal generating block 550B may generate the scan clock signal CPV having the normal frequency (e.g., the second frequency) to provide the activated scan signal to the first region during a fourth period corresponding to the first region. Subsequently, the control signal generating block 550B might not provide the activated scan signal to the second region by generating the scan clock signal CPV having a constant voltage level during a fifth period corresponding to the second region.

In addition, the control signal generating block 550B may provide the region classification information PD to the scan driver such that the scan driver can determine a start position where outputting the activated scan signal is started. Furthermore, the control signal generating block 550B may provide the region classification information PD to the data driver such that the data driver can output the data signal in accordance with a timing of the scan signal.

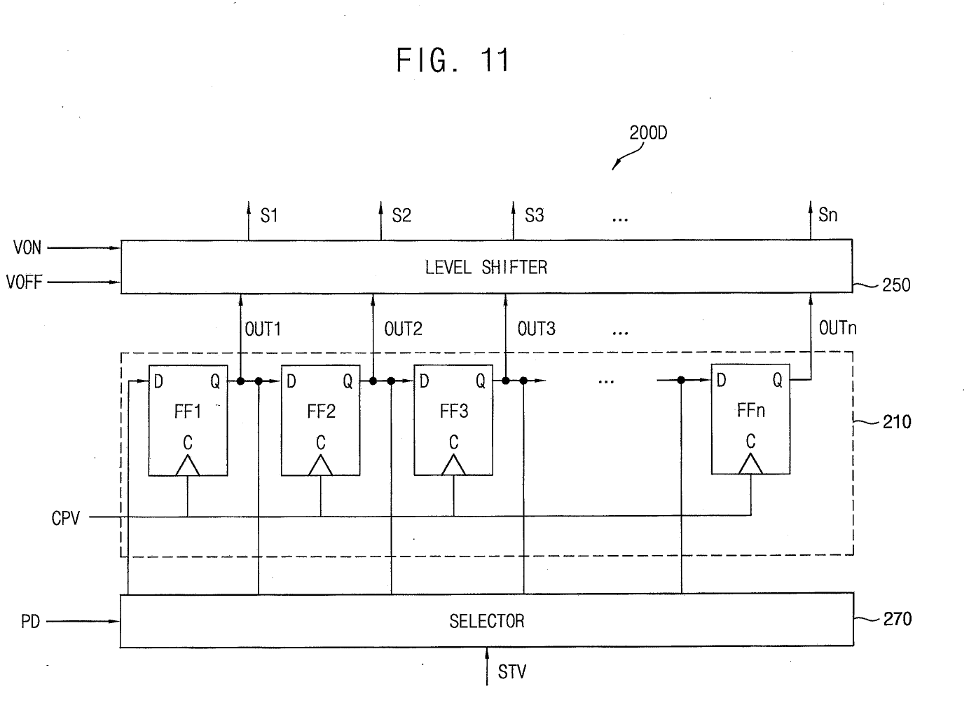

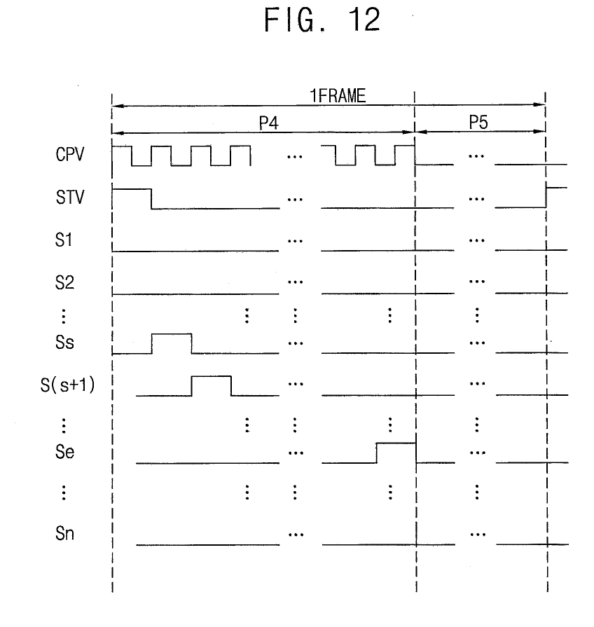

FIG. 11 is a block diagram illustrating still another example of a scan driver included in the display device of FIG. 1, and FIG. 12 is a timing diagram illustrating an example in which the scan driver of FIG. 11 is driven in a second driving mode.

Referring to FIGS. 11 and 12, the scan driver 200D may include a shift register 210, a level shifter 250, and a selector 270. Except that the scan driver 200D further includes the selector 270, the scan driver 200D is substantially the same as the scan driver 200A of FIG. 3. Thus, the same or similar reference numerals will be used for identical or similar components. In addition, duplicated description will not be repeated.

The selector 270 may provide the vertical start signal STV to the input terminal D of one stage among the first through (n)th stages FF1 through FFn based on the region classification information PD. In other words, the selector 270 may provide the vertical start signal STV to the stage corresponding to the start pixel-row of the first region based on the region classification information PD such that the activated scan signal is sequentially output from the point corresponding to the start pixel-row of the first region.

The shift register 210 may sequentially output activated output signals from the point corresponding to the start pixel-row of the first region based on the vertical start signal STV received from the selector 270 and the scan clock signal CPV.

The level shifter 250 may convert the output signals OUT1 through OUTn into the scan signals S1 through Sn having the turn-on voltage or the turn-off voltage.

As illustrated in FIG. 12, the frequency of the scan clock signal CPV may be the normal frequency (e.g., the second frequency) during the fourth period P4 of one frame. The selector 270 of the scan driver 200D may determine the stage corresponding to the start pixel-row of the first region as the (s)th stage based on the region classification information PD, and may provide the vertical start signal STV to the input terminal of the (s)th stage. Thus, the (s)th through (e)th stages may sequentially provide the activated scan signals Ss through Se to the (s)th through (e)th pixel-rows corresponding to the first region during the fourth period P4.

During the fifth period P5 of one frame, the scan clock signal CPV may have a constant voltage level. That is, the (e+1)th through (n)th stages might not provide the activated scan signal to the (e+1)th through (n)th pixel-rows corresponding to the second region during the fifth period P5.

As described above, the scan driver of FIG. 11 may output the activated scan signal to the first region without a delay time as compared to the scan driver of FIG. 3.

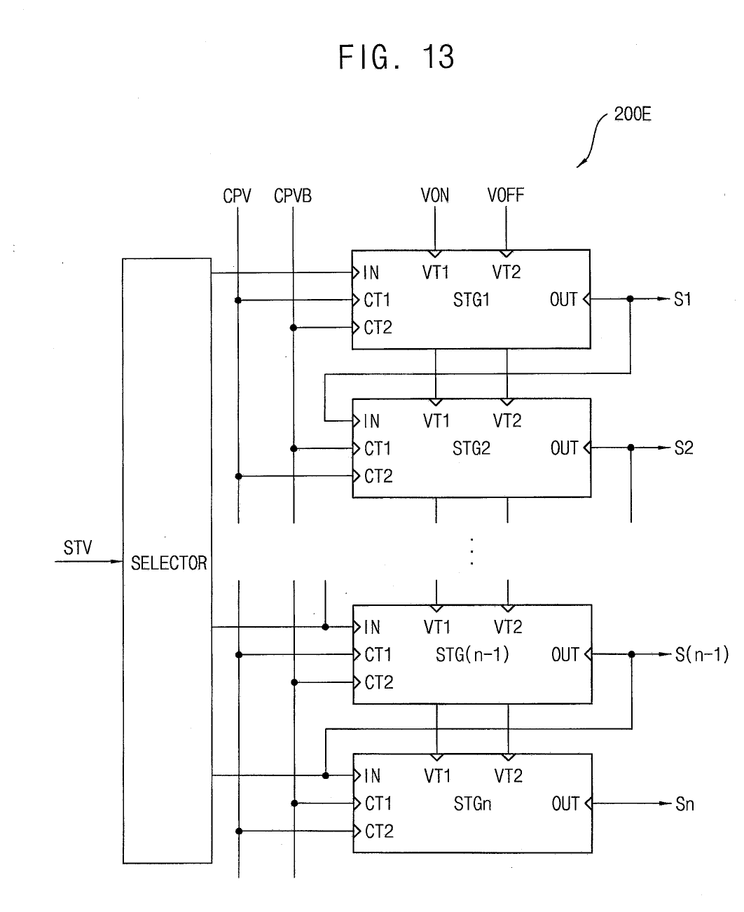

FIG. 13 is a block diagram illustrating still another example of a scan driver included in the display device of FIG. 1.

Referring to FIG. 13, the scan driver 200E may be formed on the same substrate as the display panel. The scan driver 200E may include a plurality of stages STG1 through STGn. Except that the scan driver 200E further includes the selector 270, the scan driver 200E of the present embodiment is substantially the same as the scan driver 200C of the embodiment shown in FIG. 8. Thus, the same or similar reference numerals will be used for identical or similar components. In addition, duplicated description will not be repeated.

The selector 270 may provide the vertical start signal STV to the input terminal IN of one stage among the first through (n)th stages STG1 through STGn based on the region classification information PD. In other words, the selector 270 may provide the vertical start signal STV to the stage corresponding to the start pixel-row of the first region based on the region classification information PD such that the activated scan signal is sequentially output from the point corresponding to the start pixel-row of the first region.

Because a method in which the scan driver 200E of FIG. 13 drives the display panel is substantially the same as a method in which the scan driver 200D of FIG. 11 drives the display panel, duplicated description will not be repeated.

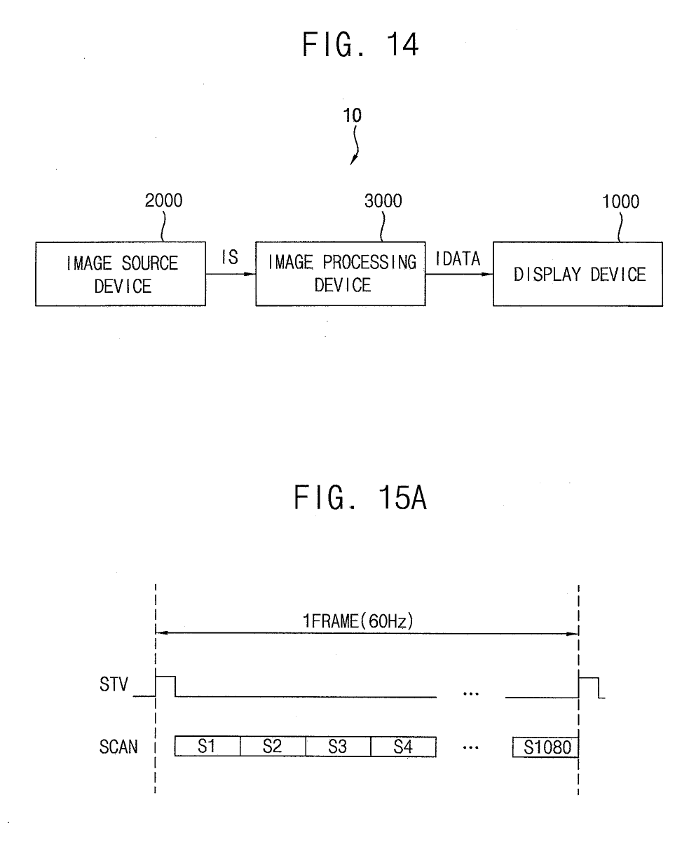

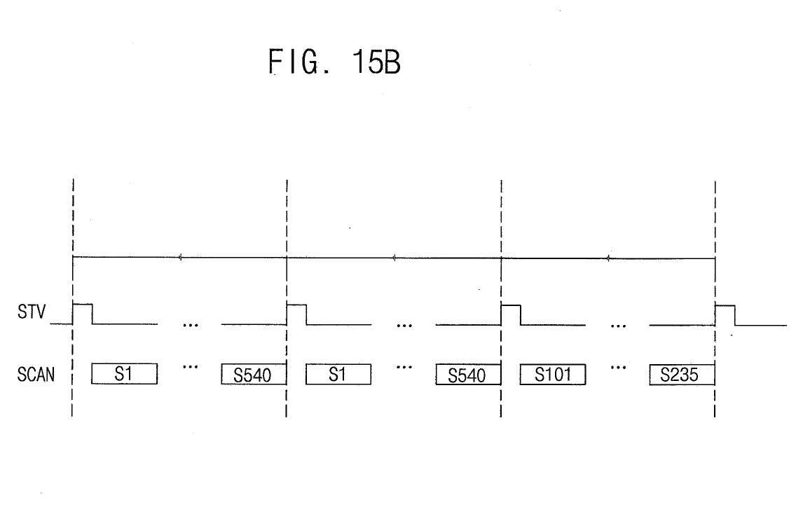

FIG. 14 is a block diagram illustrating an electronic device according to embodiments of the present disclosure, and FIGS. 15A and 15B are diagrams illustrating examples in which a frame rate is adjusted between an image processing device and a display device included in the electronic device of FIG. 14.

Referring to FIGS. 14 to 15B, the electronic device 10 may include the display device 1000, the image source device 2000, and the image processing device 3000.

The display device 1000 may receive the input image data IDATA from the image processing device 3000, and may display an image corresponding to the input image data IDATA. The display device 1000 may partially drive the display panel to reduce power consumption when the input image data IDATA is partially updated.

In an embodiment, the display device 1000 may include the display panel that includes a plurality of pixels, the scan driver that provides the scan signal to the pixels, the data driver that provides the data signal to the pixels, and a controller that varies the frequency of the scan clock signal in one frame to partially drive the display panel based on image data and that provides the scan clock signal to the scan driver. Because the display device 1000 is described above, duplicated description will not be repeated.

The image source device 2000 may provide an image source IS to the image processing device 3000. For example, the image source device 2000 may load the image source IS stored in a storage device, and may provide the loaded image source IS to the image processing device 3000.

The image processing device 3000 may generate the image data IDATA from the image source IS. For example, the image processing device 3000 may generate the input image data IDATA to be provided to the display device 1000 by performing an image processing (e.g., a rendering processing, etc.) on the image source IS.

As illustrated in FIG. 15A, the display panel may include 1st through 1080th pixel-rows. The frame rate may be 60 fps (frame/second) in the first driving mode for refreshing an entire image displayed on the display panel. When partially driving the display panel is not necessary (e.g., when in the first driving mode), the image processing device 3000 may provide the input image data IDATA for the entire region of the display panel to the display device 1000 at the frame rate of 60 fps. The display device 1000 may sequentially output 1st through 1080th scan signals S1 through S1080 that are activated to display an image corresponding to the entire region of the display panel.

As illustrated in FIG. 15B, when partially driving the display panel is suitable, the image processing device 3000 may provide the input image data IDATA for a portion image to the display device 1000. In an embodiment, when the current frame data is partially updated as compared to the previous frame data, the image processing device 3000 may provide a portion of the current frame data as the input image data IDATA to the display device 1000. In addition, the image processing device 3000 may adjust the frame rate based on a size of the portion of the current frame data provided to the display device 1000.

For example, to partially refresh the image corresponding to 1st through 540th pixel-rows, the image processing device 3000 may provide the frame data corresponding to the 1st through 540th pixel-rows to the display device 1000 at the frame rate of 120 fps. The display device 1000 may sequentially output 1st through 540th scan signals S1 through S540 that are activated and may partially refresh the image based on the frame data corresponding to the 1st through 540th pixel-rows.

In addition, to partially refresh the image corresponding to 101st through 235th pixel-rows, the image processing device 3000 may provide the frame data corresponding to the 101st through 235th pixel-rows to the display device 1000 at the frame rate of 480 fps. The display device 1000 may sequentially output 101st through 235th scan signals S101 through S235 that are activated and may partially refresh the image based on the frame data corresponding to the 101st through 235th pixel-rows.

As described above, the image processing device 3000 may determine whether the display panel is partially driven and may transmit the portion of the frame data by adjusting the frame rate between the image processing device 3000 and the display device 1000 based on the size of the portion of the frame data. As a result, the display device 1000 may be driven at a relatively high frequency.

Although a display device and an electronic device including the display device according to embodiments of the present disclosure are described above with reference to figures, those skilled in the art will readily appreciate that many modifications are possible in the embodiments of the present disclosure without materially departing from the novel teachings and advantages of the present inventive concept. For example, although it is described above that there is one-to-one correspondence between the pixel-rows and the scan-lines, the present inventive concept is not limited thereto. In addition, although it is described above that the scan driver generates a scan signal that is activated when the scan signal has a high voltage level and is deactivated when the scan signal a low voltage level, the present inventive concept is not limited thereto. For example, the scan driver may generate a scan signal that is activated when the scan signal has the low voltage level and that is deactivated when the scan signal the high voltage level.

The present inventive concept may be applied to an electronic device including a display device. For example, the present inventive concept may be applied to a computer, a laptop, a cellular phone, a video phone, a smart phone, a smart pad, a smart watch, a portable multimedia player (PMP), a personal digital assistant (PDA), an MP3 player, a digital camera, a video camcorder, etc.

The foregoing is illustrative of embodiments of the present disclosure and is not to be construed as limiting thereof. Although a few embodiments of the present disclosure have been described, those skilled in the art will readily appreciate that many modifications are possible in the embodiments of the present disclosure without materially departing from the novel teachings and advantages of the present inventive concept. Accordingly, all such modifications are intended to be included within the scope of the present inventive concept as defined in the claims. Therefore, it is to be understood that the foregoing is illustrative of various embodiments of the present disclosure and is not to be construed as limited to the specific embodiments of the present disclosure disclosed, and that modifications to the disclosed embodiments of the present disclosure, as well as other embodiments of the present disclosure including functional equivalents, are intended to be included within the scope of the appended claims.

What is claimed is:

1. A display device, comprising:
a display panel including a plurality of pixels;
a scan driver configured to provide a scan signal to the pixels;
a data driver configured to provide a data signal to the pixels; and
a controller configured to vary a frequency of a scan clock signal in one frame to partially drive the display panel, and to provide the scan clock signal to the scan driver.

2. The display device of claim 1, wherein the controller is configured to select, as a driving mode, a first driving mode in which the display panel is entirely driven, or a second driving mode in which the display panel is partially driven.

3. The display device of claim 2, wherein the pixels are arranged in a plurality of pixel-rows and a plurality of pixel-columns, and
wherein the controller is configured to classify, in the second driving mode, the pixel-rows into a first region where an image displayed on the display panel is to be refreshed, and a second region where the image displayed on the display panel is not to be refreshed.

4. The display device of claim 3, wherein, in the second driving mode, the scan driver is configured to provide the scan signal that is activated to the first region, and to provide the scan signal that is deactivated to the second region.

5. The display device of claim 2, wherein the controller is configured to select the first driving mode or the second driving mode by comparing a previous frame data of image data with a current frame data of the image data.

6. The display device of claim 1, wherein the controller is configured to provide the scan clock signal having a first frequency to the scan driver in a first period of the frame, to provide the scan clock signal having a second frequency that is lower than the first frequency to the scan driver in a second period of the frame, and to provide the scan clock signal having a constant voltage level to the scan driver in a third period of the frame.

7. The display device of claim 6, wherein the scan driver is configured to output the scan signal that is deactivated based on the scan clock signal having the first frequency or having the constant voltage level, and to output the scan signal that is activated based on the scan clock signal having the second frequency.

8. The display device of claim 1, wherein the scan driver includes:
a shift register configured to sequentially output a plurality of output signals based on the scan clock signal and a start signal;
a signal filter configured to attenuate the output signals when a frequency of the output signals is greater than a predetermined frequency; and
a level shifter configured to convert the attenuated output signals into the scan signals having a turn-on voltage or a turn-off voltage.

9. The display device of claim 8, wherein the shift register includes first through (n)th flip-flops, where n is an integer greater than 1, that are configured to output the output signals, respectively,
wherein the scan driver further includes a selector that is configured to provide the start signal to one of the first through (n)th flip-flops based on region classification information indicating a region of the display panel to be driven, and
wherein the (k)th flip-flop, where k is an integer between 2 and n, is configured to generate one of the output signals in response to the output signal of the (k−1)th flip-flop or the start signal.

10. The display device of claim 1, wherein the scan driver includes first through (n)th stages, where n is an integer greater than 1, that are configured to output respective output signals, and
wherein the (k)th stage, where k is an integer between 2 and n, is configured to output one of the output signals in response to the output signal of the (k−1)th stage or a start signal.

11. The display device of claim 10, wherein the scan driver further includes a selector that is configured to provide the start signal to one of the first through (n)th stages based on region classification information indicating a region of the display panel to be driven.

12. The display device of claim 1, wherein the controller includes:
a frame data comparing block configured to obtain a first number of pixel-rows where previous frame data is identical to current frame data;
a partial refresh determining block configured to generate region classification information for classifying the pixel-rows into a first region where an image displayed on the display panel is to be refreshed, and a second region where the image displayed on the display panel is not to be refreshed, when the first number is greater than a threshold value; and
a control signal generating block configured to vary the frequency of the scan clock signal based on the region classification information.

13. The display device of claim 12, wherein the control signal generating block is configured to provide a data clock signal of which a frequency is varied based on the region classification information to the data driver.

14. An electronic device comprising:
an image processing device configured to generate image data from an image source; and
a display device configured to display an image corresponding to the image data,
wherein the display device includes:
a display panel including a plurality of pixels;
a scan driver configured to provide a scan signal to the pixels;
a data driver configured to provide a data signal to the pixels; and
a controller configured to vary a frequency of a scan clock signal in one frame to partially drive the display panel based on the image data, and to provide the scan clock signal to the scan driver.

15. The electronic device of claim 14, wherein the image processing device partially provides current frame data of the image data to the display device when the current frame data of the image data is partially updated from previous frame data of the image data.

16. The electronic device of claim 15, wherein the image processing device is configured to determine a frame rate based on a size of a portion of the current frame data, the portion of the current frame data being provided to the display device.

17. The electronic device of claim 14, wherein the controller is configured to select a first driving mode in which the display panel is entirely driven or a second driving mode in which the display panel is partially driven as a driving mode.

18. The electronic device of claim 17, wherein the pixels are arranged in a plurality of pixel-rows and a plurality of pixel-columns, and
wherein the controller is configured to classify, in the second driving mode, the pixel-rows into a first region where an image displayed on the display panel is to be refreshed, and a second region where the image displayed on the display panel is not to be refreshed.

19. The electronic device of claim 18, wherein, in the second driving mode, the scan driver is configured to provide the scan signal that is activated to the first region, and to provide the scan signal that is deactivated to the second region.

20. The electronic device of claim 14, wherein the controller is configured to provide the scan clock signal having a first frequency to the scan driver in a first period of the frame, to provide the scan clock signal having a second frequency that is lower than the first frequency to the scan driver in a second period of the frame, and to provide the scan clock signal having a constant voltage level to the scan driver in a third period of the frame.
